(19) United States
(12) Patent Application Publication
(10) Pub. No.: US 2017/0212816 A1
(43) Pub. Date: Jul. 27, 2017

(54) SEMICONDUCTOR MEMORY DEVICE AND DATA STORAGE DEVICE INCLUDING THE SAME

(71) Applicant: SK hynix Inc., Gyeonggi-do (KR)

(72) Inventor: Sok Kyu LEE, Gyeonggi-do (KR)

(21) Appl. No.: 15/146,532

(22) Filed: May 4, 2016

(30) Foreign Application Priority Data
Jan. 27, 2016 (KR) 10-2016-0010120

(51) Int. Cl. G06F 11/20; G06F 11/16; G06F 11/10

(52) U.S. Cl. CPC G06F 11/2017; G06F 11/1044; G06F 11/1679

(57) ABSTRACT

A data storage device includes a semiconductor memory device including a memory cell array which includes a main cell area and a spare cell area; and a controller coupled with the semiconductor memory device through a plurality of main data lines and at least one spare data line, and configured to transmit main data to be stored in the main cell area, through the plurality of main data lines, and transmit spare data for managing the main data to be stored in the spare cell area, through the spare data line.

### CROSS-REFERENCES TO RELATED APPLICATION

The present application claims priority under 35 U.S.C. §119(a) to Korean application number 10-2016-0010120, filed on Jan. 27, 2016, in the Korean Intellectual Property Office, which is incorporated herein by reference in its entirety.

### BACKGROUND

1. Technical Field

Various embodiments of the present disclosure generally relate to a data storage device including a controller which transmits data to a semiconductor memory device.

2. Related Art

Recently, the paradigm for the computer environment has been converted into ubiquitous computing so that computer systems can be used anytime and anywhere. Due to this, the use of portable electronic devices such as mobile phones, digital cameras, and notebook computers has rapidly increased. In general, such portable electronic devices use a data storage device which uses a semiconductor memory device. The data storage device is used as an auxiliary memory device of the portable electronic devices.

A data storage device using a semiconductor memory device provides advantages in that, since there is no mechanical driving part, stability and durability are excellent, information access speed is high and power consumption is small. Data storage devices having such advantages include a universal serial bus (USB) memory device, memory cards having various interfaces, and a solid state drive (SSD).

As portable electronic devices play large files such as music files or video files, the data storage device is required to have a large storage capacity. For securing a large storage capacity, data storage devices use, as storage media, semiconductor memory devices having high integration for the memory cells. An example of a widely used semiconductor memory device is a flash memory device which is a nonvolatile memory device.

### SUMMARY

Various embodiments of the present disclosure are directed to a data storage device including a controller for transmitting, to a semiconductor memory device, main data through main data lines and spare data through a spare data line.

In an embodiment, a data storage device may include: a semiconductor memory device including a memory cell array which includes a main cell area and a spare cell area; and a controller coupled with the semiconductor memory device through a plurality of main data lines and at least one spare data line, and configured to transmit main data to be stored in the main cell area, through the plurality of main data lines, and transmit spare data for managing the main data to be stored in the spare cell area, through the spare data line.

In an embodiment, a semiconductor memory device may include: main memory cells coupled to main bit lines; spare memory cells coupled to spare bit lines; main data read/write circuits respectively corresponding to the main bit lines, suitable for storing data in the main memory cells or reading out data from the main memory cells; spare data read/write circuits respectively corresponding to the spare bit lines, suitable for storing data in the spare memory cells or reading out data from the spare memory cells; and a column decoder suitable for coupling main input/output lines to the main data read/write circuits and coupling a spare input/output line to the spare data read/write circuits.

According to the embodiments, throughput of a data storage device may be improved.

### BRIEF DESCRIPTION OF THE DRAWINGS

FIG. 1 is a diagram illustrating a semiconductor memory device before packaging in accordance with an embodiment of the invention.

FIG. 2 is a block diagram illustrating a semiconductor memory device in accordance with the embodiment.

FIG. 3 is a circuit diagram Illustrating a memory block BLK of a semiconductor memory device in accordance with the embodiment.

FIG. 4 is a block diagram illustrating a data storage device in accordance with an embodiment.

FIG. 5 is a diagram illustrating a data transmission method between a controller and a semiconductor memory device in accordance with the embodiment.

FIG. 6 is a diagram illustrating a state in which main data and spare data are stored in memory cells.

FIG. 7 is a block diagram Illustrating a data processing system including a data storage device in accordance with an embodiment.

FIG. 8 is a block diagram illustrating a data processing system including a solid state drive (SSD) in accordance with an embodiment.

FIG. 9 is a block diagram Illustrating a solid state drive (SSD) in accordance with an embodiment.

FIG. 10 is a block diagram illustrating a computer system to which a data storage device in accordance with an embodiment is mounted.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can practice the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or Intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a semiconductor memory device and a data storage device including the same will be described below with reference to the accompanying drawings through various examples of embodiments.

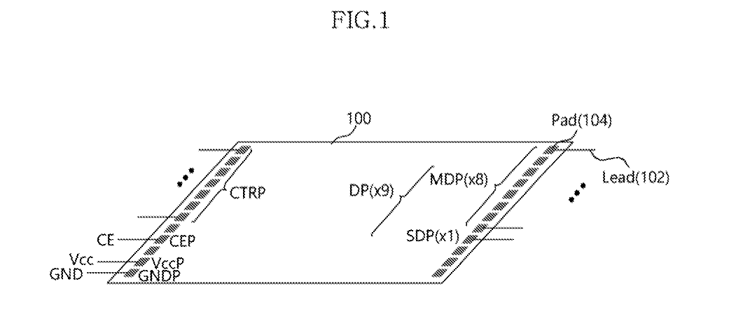

Referring now to FIG. 1 a semiconductor memory device 100, before packaging, is provided, in accordance with an embodiment of the present invention.

Referring to FIG. 1, the semiconductor memory device 100 may include a plurality of leads 102 for signal line coupling with an external device (not shown) and a plurality of pads 104 respectively coupled to the leads 102. The number of the leads 102 and the pads 104 may be optionally selected, and may be changed according as may be needed depending upon the particular type of the semiconductor memory device 100. It is noted that the ellipsis (three dots in series) in FIG. 1 represent intentionally omitted leads 102.

For operating the semiconductor memory device 100, an operation voltage Vcc may be received through an operation voltage pad VccP for the external device, and a ground voltage GND may be received through a ground voltage pad GNDP, also from the external device.

A chip enable signal (or a chip selection signal) CE for enabling the semiconductor memory device 100 may be received through a chip enable pad CEP from the external device.

Control signals (e.g., commands, addresses, clock signals, etc.) for controlling the operation of the semiconductor memory device 100 may be received through a plurality of control signal pads CTRP from the external device.

Data to be stored in the semiconductor memory device 100 or data read out from the semiconductor memory device 100 may be received or transmitted (hereinafter, collectively referred to as “transceived” or “transmitted”) through a plurality of data pads DP. Main data may only be transceived through one or more main data pads MDP. Spare data may only be transceived through one or more spare data pads SDP. In the example, of FIG. 1 main data are tranceived through a plurality of main data paths MDP, specifically 8 main data paths MDP(x8), while spare data are tranceived through a single spare data path SDP(x1). That is to say, paths for transceiving the main data and a path for transceiving the spare data may be physically distinguished. The main data and the spare data will be described below in detail.

In the example of FIG. 1, where the semiconductor memory device 100 includes 8 main data pads MDP(x8) and 1 spare data pad SDP(x1), the data pads DP are configured by 9 data pads DP(x9) and may transceive 9-bit data at a time. It is noted that such data pad configuration is Illustrated as an example only. For example, the data pads DP may be configured by a plurality of main data pads MDP and a plurality of spare data pads SDP. In an embodiment, for example, the data pads DP may include 16 main data pads MDP(x16) and 2 spare data pads SDP(x2). In this case, the data pads DP may be configured by 18 data pads DP(x18), and may transmit 18-bit data at a time.

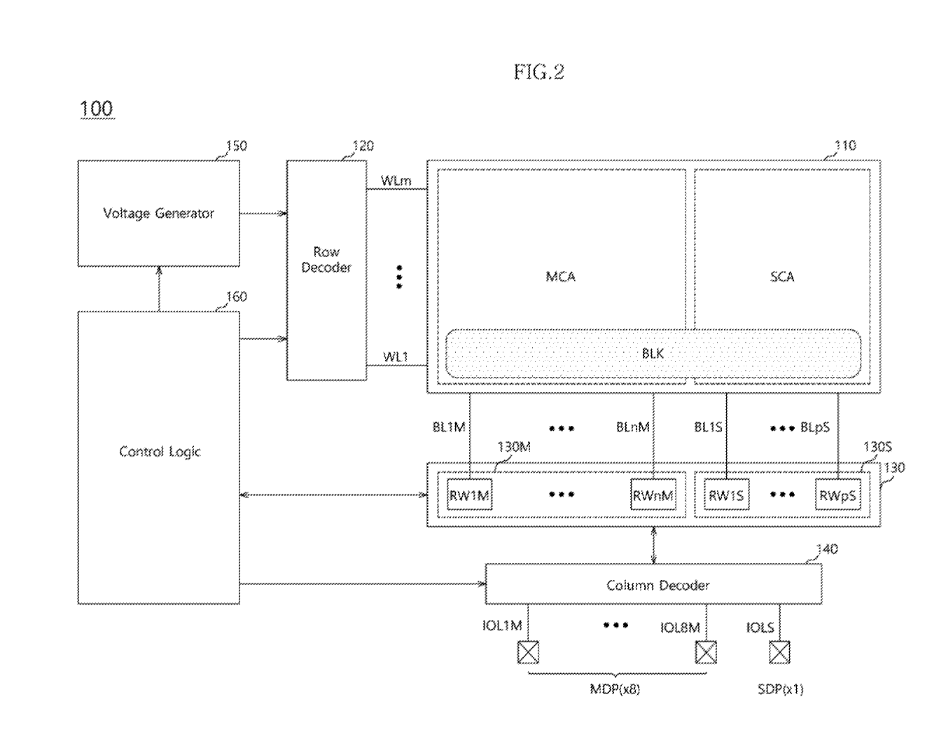

FIG. 2 is a block diagram illustrating an exemplary configuration of the semiconductor memory device 100 of FIG. 1.

According to the example of FIG. 2, the semiconductor memory device 100 may include a memory cell array 110, a row decoder 120, a data read/write block 130, a column decoder 140, a voltage generator 150, and a control logic 160.

The memory cell array 110 may include a main cell area MCA including main memory cells which are arranged at areas where word lines WL1 to WLm and main bit lines BL1M to BLnM intersect with each other. Also, the memory cell array 110 may include a spare cell area SCA including spare memory cells which are arranged at areas where the word lines WL1 to WLm and spare bit lines BL1S to BLpS intersect with each other.

The main memory cells of the main cell area MCA and the spare memory cells of the spare cell area SCA corresponding thereto may be grouped by access units such as a memory block BLK as an erase unit and a page as a program and read unit.

The row decoder 120 may be coupled with the memory cell array 110 through the word lines WL1 to WLm. The row decoder 120 may operate according to control of the control logic 160. The row decoder 120 may decode addresses provided from an external device (not shown). The row decoder 120 may select and drive one or more of the word lines WL1 to WLm, based on the address decoding results. For instance, the row decoder 120 may provide a word line voltage provided from the voltage generator 150, to a word line selected from the word lines WL1 to WLm according to the address decoding results.

The data read/write block 130 may operate according to control of the control logic 160. The data read/write block 130 may operate as a write driver or a sense amplifier according to respective operation modes. For example, in a write operation, the data read/write block 130 may operate as a write driver which stores data provided from the external device in memory cells of the memory cell array 110. For another example, in a read operation, the data read/write block 130 may operate as a sense amplifier which reads out data from memory cells of the memory cell array 110.

The data read/write block 130 may include a main data read/write block 130M and a spare data read/write block 130S. The main data read/write block 130M may be coupled with the main cell area MCA through the main bit lines BL1M to BLnM. The main data read/write block 130M may include main read/write circuits RW1M to RWnM respectively corresponding to the main bit lines BL1M to BLnM. The spare data read/write block 130S may be coupled with the spare cell area SCA through the spare bit lines BL1S to BLpS. The spare data read/write block 130S may include spare read/write circuits RW1S to RWpS respectively corresponding to the spare bit lines BL1S to BLpS.

The column decoder 140 may operate according to control of the control logic 160. The column decoder 140 may decode addresses provided from the external device. The column decoder 140 may couple the main read/write circuits RW1M to RWnM of the main data read/write block 130M (corresponding to the respective main bit lines BL1M to BLnM) with respective main data input/output lines IOL1M to IOL8M coupled to the main data pads MDP, based on the decoding results. The column decoder 140 may couple the spare read/write circuits RW1S to RWpS of the spare data read/write block 130S (corresponding to the respective spare bit lines BL1S to BLpS) with a spare data input/output line IOLS coupled to the spare data pad SDP, based on the decoding results. In other words, by a switching operation of the column decoder 140 based on the address decoding results, data to be stored to, or read out from the main cell area MCA may be transceived through the main data pads MPD, whereas data to be stored to, or read out from the spare cell area SCA may be transceived through the spare data pad SDP.

The voltage generator 150 may generate voltages to be used in internal operations (e.g., read, write and erase operations) of the semiconductor memory device 100, under the control of the control logic 160. The voltages generated by the voltage generator 150 may be applied to the memory cells of the memory cell array 110 through the row decoder 120 as may be needed.

The control logic 160 may control the general operations of the semiconductor memory device 100, based on control signals provided from the external device. For example, the control logic 160 may control main operations of the semiconductor memory device 100, such as, for example, read, program and erase operations of the semiconductor memory device 100.

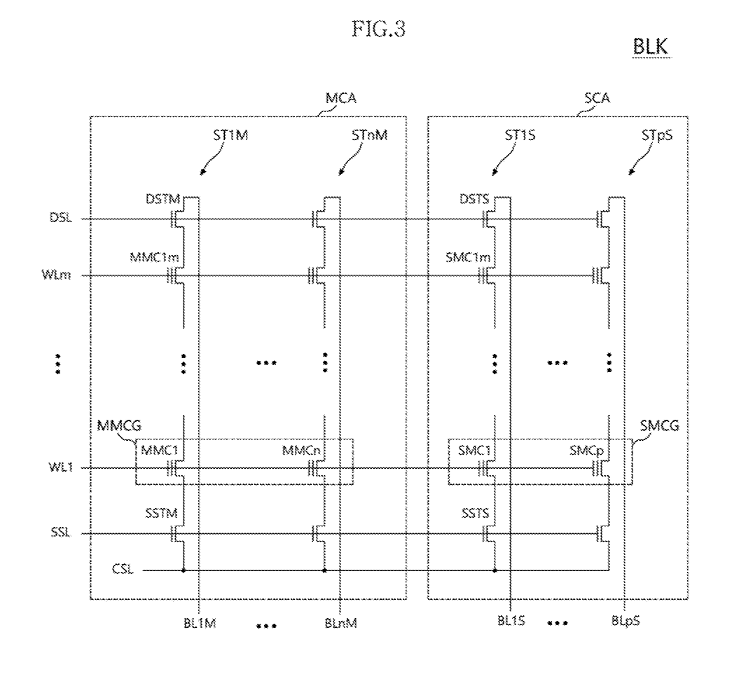

FIG. 3 is a circuit diagram illustrating an exemplary configuration of memory block BLK of the memory cell array 110 employed in the semiconductor memory device 100 in accordance with the embodiment of FIG. 2. As described above, the main memory cells of the main cell area MCA and the spare memory cells of the spare cell area SCA corresponding thereto may be grouped by the unit of a memory block BLK. The memory cell array 110 may include a plurality of memory blocks.

Each of the plurality of memory blocks may be configured like the memory block BLK shown in FIG. 3. The memory block BLK may include a main cell area MCA and a spare cell area SCA.

The main cell area MCA may include a plurality of main cell strings ST1M to STnM which are coupled to the plurality of main bit lines BL1M to BLnM, respectively. The main cell strings ST1M to STnM have the same circuit configuration, and for the sake of convenience in explanation, a first main cell string ST1M will be representatively described below.

The first main cell string ST1M may include a plurality of main memory cells MMC1 to MMC1m and select transistors DSTM and SSTM which are coupled between a first main bit line BLM and a common source line CSL. In detail, the first main cell string ST1M may include a drain select transistor DSTM which is coupled to a drain select line DSL, the plurality of main memory cells MMC1 to MMC1m which are respectively coupled to the plurality of word lines WL1 to it WLm, and a source select transistor SSTM which is coupled to a source select line SSL.

The spare cell area SCA may include a plurality of spare cell strings ST1S to STpS which are coupled to the plurality of spare bit lines BL1S to BLpS. The spare cell strings ST1S to STpS have the same circuit configuration, and for the sake of convenience in explanation, a first spare cell string ST1S will be representatively described below.

The first spare cell string ST1S may include a plurality of spare memory cells SMC1 to SMC1m and select transistors DSTS and SSTS which are coupled between a first spare bit line BL1S and the common source line CSL. In detail, the first spare cell string ST1S may include a drain select transistor DSTS which is coupled to the drain select line DSL, the plurality of spare memory cells SMC1 to SMC1m which are respectively coupled to the plurality of word lines WL1 to WLm, and a source select transistor SSTS which is coupled to the source select line SSL.

Data (or user data) for a write operation requested from a host device (or a user device) which uses a data storage device as a memory device may be stored in the main cell area MCA. Metadata, i.e., data related to the user data stored in the corresponding main cell area MCA may be stored in the spare cell area SCA. Hereafter, data for a write operation requested from the host device (or the user device) will be referred to as “main data,” and metadata related with the main data will be referred to as “spare data.” For instance, the main data may be stored in main memory cells MMC1 to MMCn which are grouped as a main memory cell group MMCG. Spare data of the main data stored in the main memory cell group MMCG may be stored in spare memory cells SMC1 to SMCp which are grouped as a spare memory cell group SMCG corresponding to the main memory cell group MMCG.

Spare data may include information for managing the main data. For example, the spare data may include error correction codes for detecting and correcting an error of the main data. For another example, the spare data may include information for managing randomized main data. For further another example, the spare data may include Information which indicates an attribute of the main data. For still another example, the spare data may include information which indicates whether the main data is data for write directly requested from the host device or data for write obtained by rewriting data requested from the host device through an internal management operation of a data storage device.

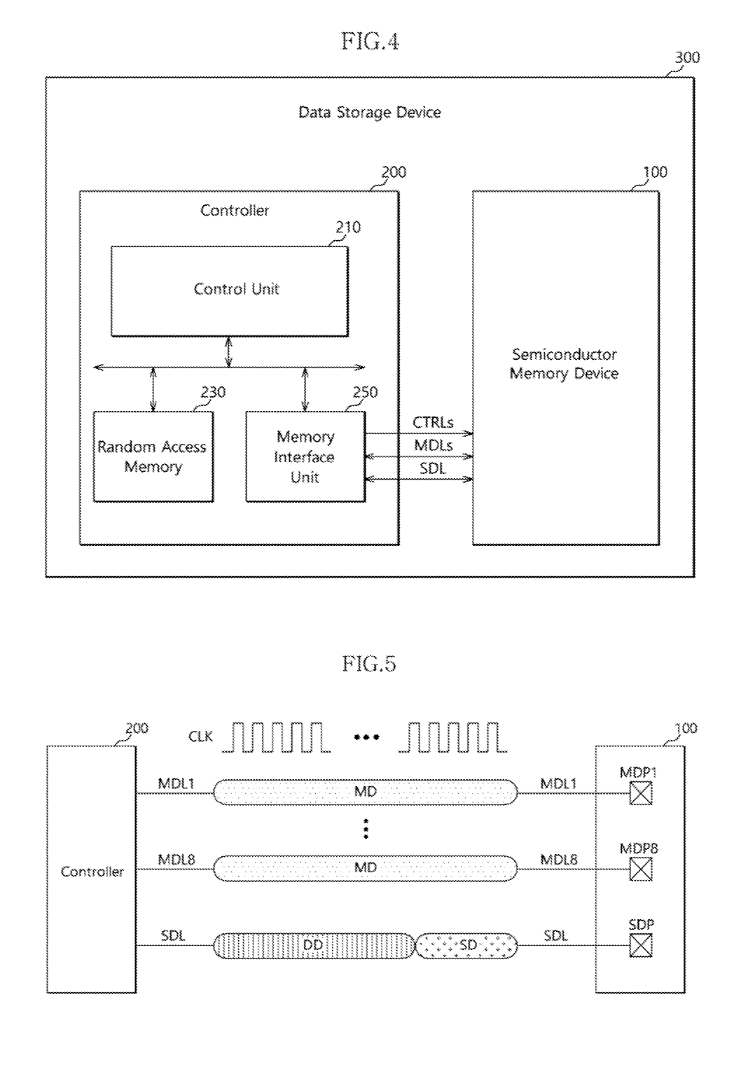

Spare data may be generated by a controller of a data storage device (e.g., a controller 200 of a data storage device 300 in FIG. 4) which uses the semiconductor memory device 100 as a storage medium. Namely, while the main data stored in the main cell area MCA is generated and managed by the host device (or the user device) which uses a data storage device as a memory device, the spare data stored in the spare cell area SCA may be generated and managed by the controller of the data storage device which uses the semiconductor memory device 100 as a storage medium. The spare cell area SCA may be a hidden area to which access is restricted, unlike the main cell area MCA for storing the main data for which access may be unrestricted.

FIG. 4 is a block diagram illustrating a data storage device 300 in accordance with an embodiment of the invention. The data storage device 300 may store data to be accessed by a host device (or a user device) such as, for example, a mobile phone, an MP3 player, a laptop computer, a desktop computer, a game player, a TV, an in-vehicle infotainment system, and the like. That is to say, the data storage device 300 may be used as a memory device of the host device. The data storage device 300 may also be referred to as a memory system.

The data storage device 300 may be manufactured as any one of various kinds of storage devices according to the protocol of an interface which is electrically coupled with the host device. For example, the data storage device 300 may be configured as any one of various kinds of storage devices such as a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component Interconnection (PCI) card type storage device, a PCI express (PCI-E) card type storage device, a compact flash (CF) card, a smart media card, a memory stick, and the like.

The data storage device 300 may be manufactured as any one of various kinds of package types, such as, for example, a package-on-package (POP), a system-in-package (SIP), a system-on-chip (SOC), a multi-chip package (MCP), a chip-on-board (COB), a wafer-level fabricated package (WFP), a wafer-level stack package (WSP) and the like.

The data storage device 300 may include a semiconductor memory device 100. The semiconductor memory device 100 may be used as the storage medium of the data storage device 300. The semiconductor memory device 100 may be or comprise the semiconductor memory device 100 shown in FIG. 2. The semiconductor memory device 100 may be or comprise any one of various types of suitable memory devices such as, for example, a flash memory device, a ferroelectric random access memory (FRAM) using ferroelectric capacitors, a magnetic random access memory (MRAM) using a tunneling magneto-resistive (TMR) layer, a phase change random access memory (PRAM) using a chalcogenide alloy, a resistive random access memory (RERAM) using a transition metal oxide, and the like.

The data storage device 300 may include a controller 200. The controller 200 may include a control unit 210, a random access memory 230, and a memory interface unit 250.

The control unit 210 may control the general operations of the controller 200. The control unit 210 may analyze and process a signal or a request which is inputted from the host device. To this end, the control unit 210 may decode and drive a software loaded on the random access memory 230. The control unit 210 may be realized in the form of a hardware or in the combined form of a hardware and a software.

The random access memory 230 may store a software to be driven by the control unit 210. Also, the random access memory 230 may store metadata such as data necessary for driving the software and data generated and managed while driving the software. That is to say, the random access memory 230 may operate as a working memory of the control unit 210. The random access memory 230 may be configured to temporarily store data to be transmitted from the host device to the semiconductor memory device 100, or from the semiconductor memory device 100 to the host device. The random access memory 230 may operate as a data buffer memory, or a data cache memory.

The memory interface unit 250 may control the semiconductor memory device 100 according to control of the control unit 210. The memory interface unit 250 may generate control signals to be provided to the semiconductor memory device 100 and transmit the generated control signals to the semiconductor memory device 100 through control signal lines CTRLs. The control signals may include commands, addresses, clock signals and the like for controlling the semiconductor memory device 100. The memory interface unit 250 may transceive main data from or to the semiconductor memory device 100 through main data lines MDLs. The memory interface unit 250 may transceive spare data from/to the semiconductor memory device 100 through a spare data line SDL.

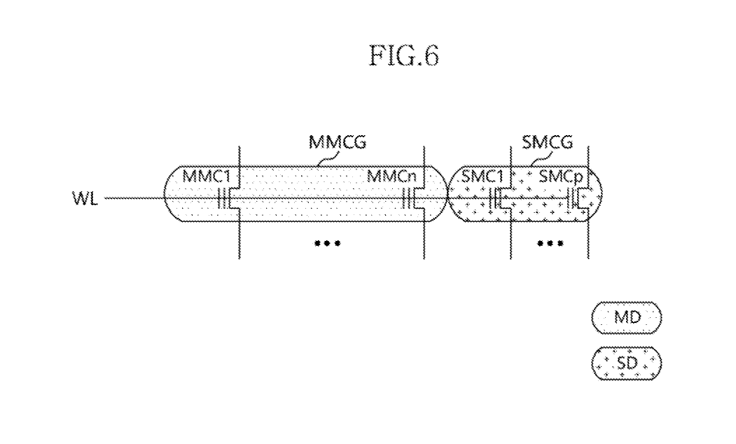

FIG. 5 is a diagram Illustrating a data transmission method between a controller 200 and a semiconductor memory device 100 in accordance with an embodiment of the invention. FIG. 6 is a diagram Illustrating a state in which main data and spare data transmitted from the controller 200 to the semiconductor memory device 100 are stored in memory cells.

Referring to FIG. 5, there is schematically shown a state in which data pads MDP1 to MDP8 and SDP among the pads of the semiconductor memory device 100 are coupled with the controller 200 through data signal lines MDL1 to MDL8 and SDL, respectively.

Main data MD may be transceived between the controller 200 and the semiconductor memory device 100 through main data lines MDL1 to MDL8. For instance, the main data MD may be transmitted 8 bits by 8 bits through the main data lines MDL1 to MDL8. Spare data SD may be transceived between the controller 200 and the semiconductor memory device 100 through a spare data line SDL. For instance, the spare data SD may be transmitted 1 bit by 1 bit through the 1 spare data line SDL.

The main data MD and the spare data SD may be transceived in synchronization with the rising edge or the falling edge of a clock signal CLK for data transmission. For example, 8-bit main data MD and 1-bit spare data SD may be transceived in synchronization with one clock signal CLK. For data transmission, the controller 200 may provide the clock signal CLK to the semiconductor memory device 100. The size of the main data MD may be larger than the size of the spare data SD. Therefore, after the spare data SD is completely transmitted, the controller 200 may transmit meaningless data (i.e., dummy data DD) until the main data MD is completely transmitted.

Even though the dummy data DD may be transmitted following the spare data SD, the dummy data DD is not stored in memory cells. As shown in FIG. 6, the main data MD may be stored in main memory cells MMC1 to MMCn of a main memory cell group MMCG, the spare data SD may be stored in spare memory cells SMC1 to SMCp of a spare memory cell group SMCG. The dummy data DD are not be stored in any memory cell.

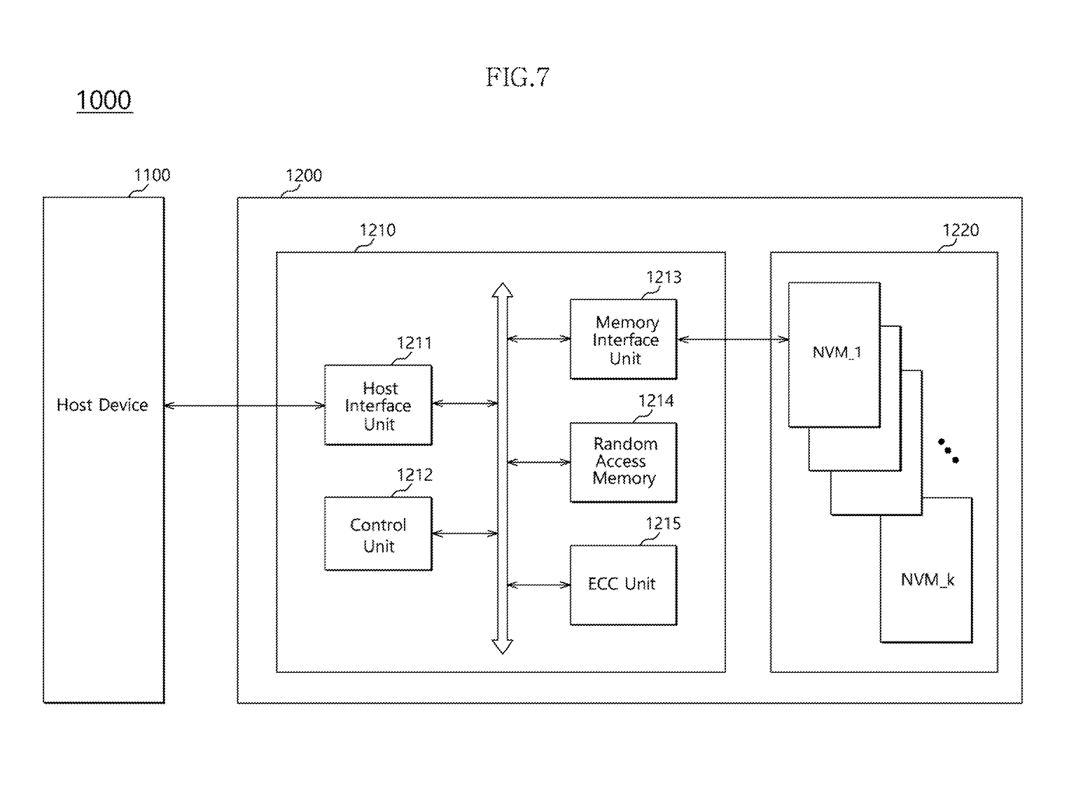

FIG. 7 is a block diagram illustrating a data processing system 1000 including a data storage device 1200 in accordance with an embodiment of the invention.

Referring to FIG. 7, the data processing system 1000 may include a host device 1100 and the data storage device 1200. The data storage device 1200 may include a controller 1210 and a nonvolatile memory device 1220. The data storage device 1200 may be used by being coupled to the host device 1100. The data storage device 120 may be an integral part of a host device, such as, for example, a mobile phone, an MP3 player, a laptop computer, a desktop computer, a game player, a TV, an in-vehicle infotainment system, and the like.

The controller 1210 may include a host interface unit 1211, a control unit 1212, a memory interface unit 1213, a random access memory 1214, and an error correction code (ECC) unit 1215.

The control unit 1212 may control the general operations of the controller 1210 in response to a request from the host device 1100. The control unit 1212 may drive a firmware or a software for controlling the nonvolatile memory device 1220.

The random access memory 1214 may be used as a working memory of the control unit 1212. The random access memory 1214 may be used as a buffer memory which temporarily stores data read out from the nonvolatile memory device 1220 or data provided from the host device 1100.

The host interface unit 1211 may interface the host device 1100 and the controller 1210. For example, the host interface unit 1211 may communicate with the host device 1100 through one of various interface protocols such as, for example, a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, a serial attached SCSI (SAS) protocol and the like.

The memory interface unit 1213 may interface the controller 1210 and the nonvolatile memory device 1220. The memory interface unit 1213 may provide commands and addresses to the nonvolatile memory device 1220. Furthermore, the memory interface unit 1213 may exchange data with the nonvolatile memory device 1220. Any suitable memory interface may be used.

The error correction code (ECC) unit 1215 may detect an error of data read out from the nonvolatile memory device 1220. Also, the error correction code (ECC) unit 1215 may be configured to correct a detected error when the detected error is within a correctable range. Any suitable ECC unit may be used.

The nonvolatile memory device 1220 may be used as the storage medium of the data storage device 1200. The nonvolatile memory device 1220 may include a plurality of nonvolatile memory chips (or dies) NVM_1 to NVM_k. Each of the nonvolatile memory chips NVM_1 to NVM_k may be configured by the semiconductor memory device 100 described above with reference to FIG. 2. Each of the nonvolatile memory chips NVM_1 to NVM_k may exchange main data through main data lines and spare data through a spare data line with the memory interface unit 1213, as described above with reference to FIG. 5.

The controller 1210 and the nonvolatile memory device 1220 may be manufactured as any one of various data storage devices. For example, the controller 1210 and the nonvolatile memory device 1220 may be integrated into a single semiconductor device and may be manufactured as any one of a multimedia card in the form of an MMC, an eMMC, an RS-MMC and a micro-MMC, a secure digital card in the form of an SD, a mini-SD and an micro-SD, a universal serial bus (USB) storage device, a universal flash storage (UFS) device, a Personal Computer Memory Card International Association (PCMCIA) card, a compact flash (CF) card, a smart media card, a memory stick, and the like.

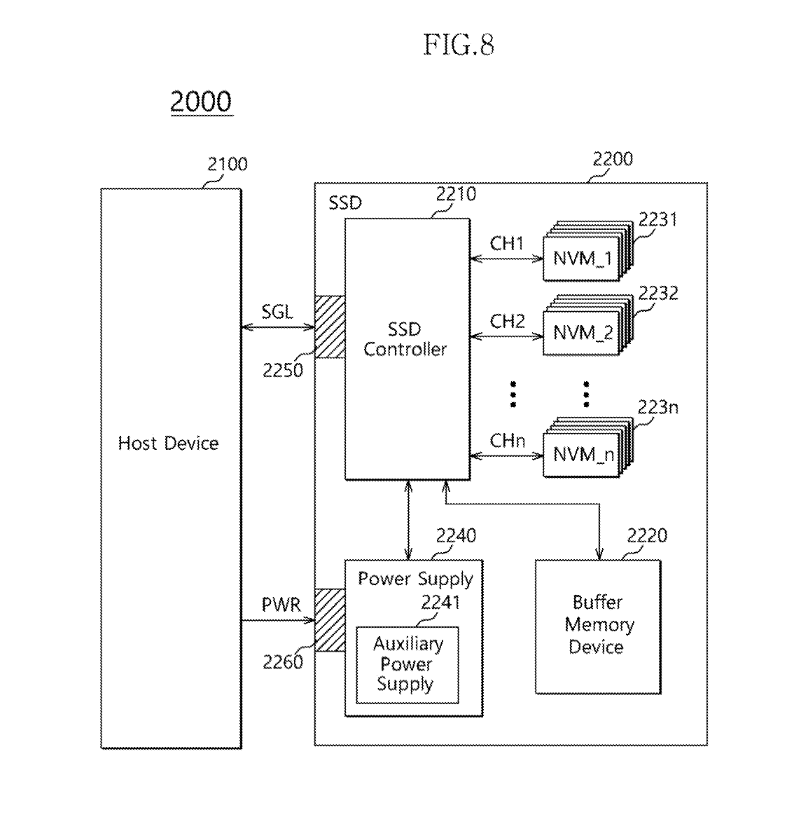

FIG. 8 is a block diagram illustrating a data processing system 2000 including a solid state drive (SSD) 220 in accordance with an embodiment of the invention.

Referring to FIG. 8, the data processing system 2000 may include a host device 2100 and the solid state drive (SSD) 2200.

The SSD 2200 may include an SSD controller 2210, a buffer memory device 2220, nonvolatile memory devices 2231 to 223n, a power supply 2240, a signal connector 2250, and a power connector 2260.

The SSD controller 2210 may access the nonvolatile memory devices 2231 to 223n in response to a request from the host device 2100.

The buffer memory device 2220 may temporarily store data which are to be stored in the nonvolatile memory devices 2231 to 223n. Further, the buffer memory device 2220 may temporarily store data which are read out from the nonvolatile memory devices 2231 to 223n. The data temporarily stored in the buffer memory device 2220 may be transmitted to the host device 2100 or the nonvolatile memory devices 2231 to 223n under control of the SSD controller 2210.

The nonvolatile memory devices 2231 to 223n may be used as storage media of the SSD 2200. Each of the nonvolatile memory devices 2231 to 223n may be configured by the semiconductor memory device 100 described above with reference to FIG. 2. The nonvolatile memory devices 2231 to 223n may be coupled with the SSD controller 2210 through a plurality of channels CH1 to CHn, respectively. One or more nonvolatile memory devices may be coupled to one channel. The nonvolatile memory devices coupled to one channel may be coupled to the same signal bus and data bus.

The power supply 2240 may provide power PWR inputted through the power connector 2260, to the inside of the SSD 2200. The power supply 2240 may include an auxiliary power supply 2241. The auxiliary power supply 2241 may supply power so as to allow the SSD 2200 to be normally terminated when a sudden power-off occurs. The auxiliary power supply 2241 may include capacitors capable of charging power PWR.

The SSD controller 2210 may exchange a signal SGL with the host device 2100 through the signal connector 2250. The signal SGL may include a command, an address, data, and the like. The signal connector 2250 may be configured by a connector such as one of parallel advanced technology attachment (PATA), serial advanced technology attachment (SATA), small computer system interface (SCSI), serial attached SCSI (SAS), peripheral component interconnection (PCI), PCI express (PCI-E), universal flash storage (UFS) protocols, and the like, according to an interface scheme between the host device 2100 and the SSD 2200.

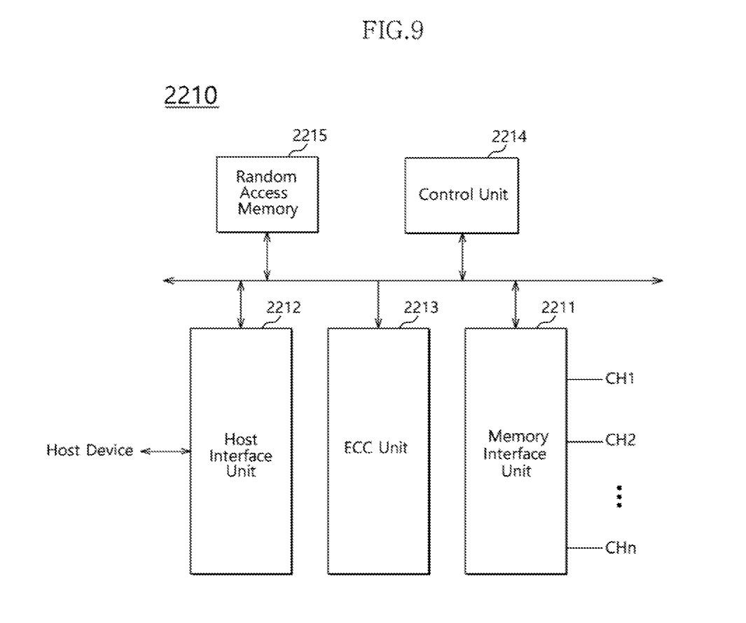

FIG. 9 is a block diagram illustrating a representation of an example of the SSD controller 2210 shown in FIG. 8.

Referring to FIG. 9, the SSD controller 2210 may include a memory interface unit 2211, a host interface unit 2212, an error correction code (ECC) unit 2213, a control unit 2214, and a random access memory 2215.

The memory interface unit 2211 may provide control signals, such as commands and addresses to the nonvolatile memory devices 2231 to 223n. Moreover, the memory interface unit 2211 may exchange data with the nonvolatile memory devices 2231 to 223n. The memory interface unit 2211 may exchange main data through main data lines and spare data through a spare data line with the nonvolatile memory devices 2231 to 223n, as described above with reference to FIG. 5.

The memory interface unit 2211 may scatter data transmitted from the buffer memory device 2220 to the respective channels CH1 to CHn, under control of the control unit 2214. Furthermore, the memory interface unit 2211 may transmit data read out from the nonvolatile memory devices 2231 to 223n to the buffer memory device 2220, under control of the control unit 2214.

The host interface unit 2212 may provide an interface with the host device 2100 in correspondence to a certain protocol. For example, the host interface unit 2212 may communicate with the host device 2100 through one of parallel advanced technology attachment (PATA), serial advanced technology attachment (SATA), small computer system interface (SCSI), serial attached SCSI (SAS), peripheral component interconnection (PCI), PCI express (PCI-E), universal flash storage (UFS) protocols, and the like. The host interface unit 2212 may perform a disk emulating function of supporting the host device 2100 to recognize the SSD 2200 as a hard disk drive (HDD).

The ECC unit 2213 may generate parity data based on data to be transmitted to the nonvolatile memory devices 2231 to 223n. The generated parity data may be stored, along with data, in the nonvolatile memory devices 2231 to 223n. The ECC unit 2213 may detect an error of data read out from the nonvolatile memory devices 2231 to 223n. When a detected error is within a correctable range, the ECC unit 2213 may correct the detected error.

The control unit 2214 may analyze and process the signal SGL inputted from the host device 2100. The control unit 2214 may control operations of the buffer memory device 2220 and the nonvolatile memory devices 2231 to 223n according to a firmware or a software for driving the SSD 2200.

The random access memory 2215 may be used as a working memory for driving the firmware or the software.

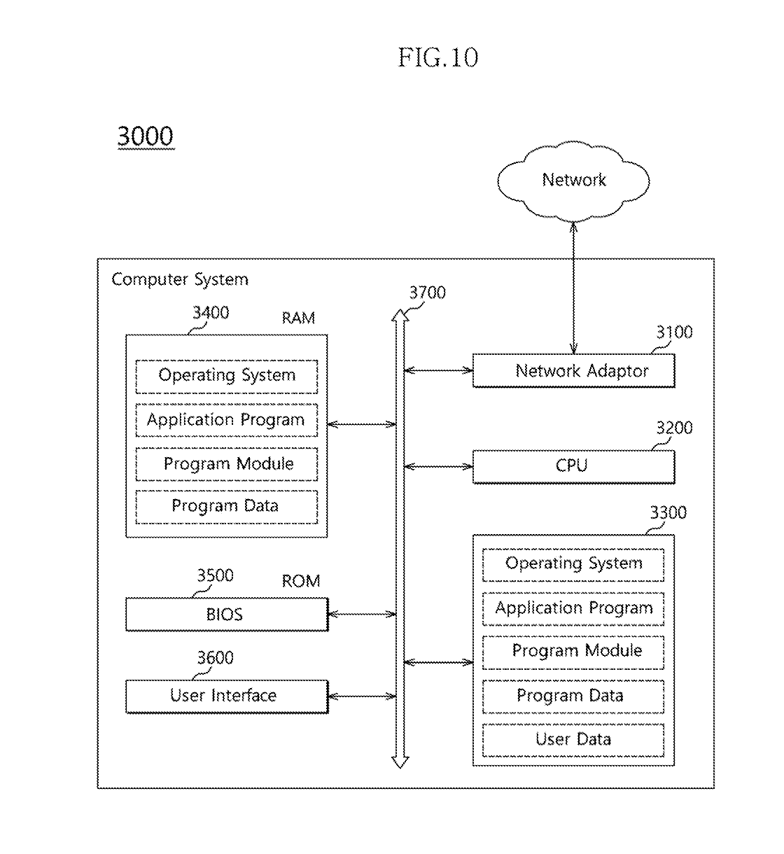

FIG. 10 is a block diagram illustrating a computer system 3000 to which a data storage device 3300 in accordance with an embodiment is mounted.

Referring to FIG. 10, the computer system 3000 may include a network adaptor 3100, a central processing unit (CPU) 3200, the data storage device 3300, a random access memory (RAM) 3400, a read only memory (ROM) 3500 and a user interface 3600, which are electrically coupled to a system bus 3700. The data storage device 3300 may be configured by the data storage device 300 shown in FIG. 4, the data storage device 1200 shown in FIG. 7 or the SSD 2200 shown in FIG. 8.

The network adaptor 3100 may provide interfacing between the computer system 3000 and external networks. The central processing unit 3200 may perform general calculation processing for driving an operating system residing at the RAM 3400 or an application program.

The data storage device 3300 may store general data needed in the computer system 3000. For example, an operating system for driving the computer system 3000, an application program, various program modules, program data and user data may be stored in the data storage device 3300.

The RAM 3400 may be used as the working memory of the computer system 3000. Upon booting, the operating system, the application program, the various program modules and the program data needed for driving programs, which are read out from the data storage device 3300, may be loaded on the RAM 3400. A basic input/output system (BIOS) which is activated before the operating system is driven may be stored in the ROM 3500. Information exchange between the computer system 3000 and a user may be implemented through the user interface 3600.

While various embodiments have been described above, it will be understood to those skilled in the art that the embodiments described are examples only. Accordingly, the semiconductor memory device and the data storage device including the same described herein should not be limited based on the described embodiments. Hence, it should be understood that many other embodiments and variations thereof may be envisaged by the skilled person in the relevant art without departing from the spirit and or scope of the present invention as defined in the claims.

What is claimed is:

1. A data storage device comprising:
a semiconductor memory device including a memory cell array which includes a main cell area and a spare cell area; and
a controller coupled with the semiconductor memory device through a plurality of main data lines and at least one spare data line, and configured to transmit main data to be stored in the main cell area, through the plurality of main data lines, and transmit spare data for managing the main data to be stored in the spare cell area, through the spare data line.

2. The data storage device according to claim 1, wherein the spare data comprises error correction codes for detecting and correcting an error of the main data.

3. The data storage device according to claim 1, wherein the spare data comprises information for managing randomized main data, in the case where the main data is randomized.

4. The data storage device according to claim 1, wherein the spare data comprises information which indicates an attribute of the main data.

5. The data storage device according to claim 1, wherein the main data comprises data for a write operation to the main cell area.

6. The data storage device according to claim 5, wherein the spare data comprises information which indicates whether the main data is data for a write operation requested directly from a host device.

7. The data storage device according to claim 5, wherein the spare data comprises information which indicates whether the main data is data obtained by rewriting data for a write operation requested from a host device through an internal management operation.

8. The data storage device according to claim 1,
wherein the controller provides a clock signal for transmitting the main data and the spare data, to the semiconductor memory device.

9. The data storage device according to claim 8,
wherein the main data and the spare data are transmitted in synchronization with the clock signal.

10. The data storage device according to claim 9, wherein, after the spare data to be stored in the spare cell area is completely transmitted, the controller transmits dummy data through the spare data line until the main data is completely transmitted.

11. The data storage device according to claim 1, wherein the semiconductor memory device transmits main data read out from the main cell area only through the plurality of main data lines, and transmits spare data read out from the spare cell area only through the spare data line.

12. A semiconductor memory device comprising:
main memory cells coupled to main bit lines;
spare memory cells coupled to spare bit lines;
main data read/write circuits respectively corresponding to the main bit lines, suitable for storing data in the main memory cells or reading out data from the main memory cells;
spare data read/write circuits respectively corresponding to the spare bit lines, suitable for storing data in the spare memory cells or reading out data from the spare memory cells; and
a column decoder suitable for coupling main input/output lines to the main data read/write circuits and coupling a spare input/output line to the spare data read/write circuits.

13. The semiconductor memory device according to claim 12, further comprising:
main data pads suitable for coupling the main input/output lines with external main data lines.

14. The semiconductor memory device according to claim 12, further comprising:
a spare data pad suitable for coupling the spare input/output line with an external spare data line.

15. The semiconductor memory device according to claim 12,
wherein the main memory cells store main data, and
wherein the spare memory cells store spare data for managing the main data stored in the main memory cells.

16. The semiconductor memory device according to claim 15, wherein the spare data comprises one of error correction codes for detecting and correcting an error of the main data, information for managing randomized main data, in the case where the main data is randomized, and information which indicates an attribute of the main data.

17. The semiconductor memory device according to claim 15, wherein the main data comprises data for write to the main memory cells.

18. The semiconductor memory device according to claim 12, wherein the main input/output lines comprise 8 main input/output lines, and the spare input/output line comprises 1 spare input/output line.
